(19) United States
(12) Patent Application Publication
(10) Pub. No.: US 2013/0006894 A1
(43) Pub. Date: Jan. 3, 2013

(54) SYSTEM FOR CALCULATING THE COST-PER-UNIT OF INK

(76) Inventors: Jerry Richard Jones, Indianapolis, IN (US); James Richard Fall, Indianapolis, IN (US); Kenneth Ross Howe, Greenwood, IN (US)

(21) Appl. No.: 13/462,251

(22) Filed: May 2, 2012

Related U.S. Application Data
(60) Provisional application No. 61/481,580, filed on May 2, 2011.

(51) Int. Cl. G06Q 30/00

(52) U.S. Cl. 705/400

(57) ABSTRACT

A computer receives information about ink usage by a printing device over a period of time. The computer calculates a cost-per-unit of ink for the printing device based on a cost of printer sustainment and based on the ink usage information. The computer may output the cost-per-unit of ink on an external device.

### CROSS REFERENCE TO RELATED APPLICATIONS

The present application claims the benefit of U.S. Provisional Patent Application No. 61/481,580 filed May 2, 2011, which is incorporated herein by reference in its entirety.

### BACKGROUND

The present application relates to printing devices, and more particularly, but not exclusively, relates to a system for analyzing the cost of printing.

Large format printing devices generally use ink to print images. Some existing systems have various shortcomings relative to certain applications. Accordingly, there remains a need for further contributions in this area of technology.

### SUMMARY

One embodiment of the present application is directed to a unique cost analysis system. Other embodiments include unique methods, systems, devices, and apparatus to analyze the cost of printing. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic diagram of a system.

FIG. 2 is a schematic diagram of a computer.

FIG. 3 is a schematic diagram of a computer with a processing subsystem.

FIG. 4 is a schematic flow diagram for a procedure for conducting an ink usage study and data processing.

FIG. 5 is a schematic flow diagram for calculating a cost-per-unit of ink.

FIG. 6 is a schematic diagram of a computer module for adjusting a cost-per-unit of ink.

### DETAILED DESCRIPTION OF REPRESENTATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

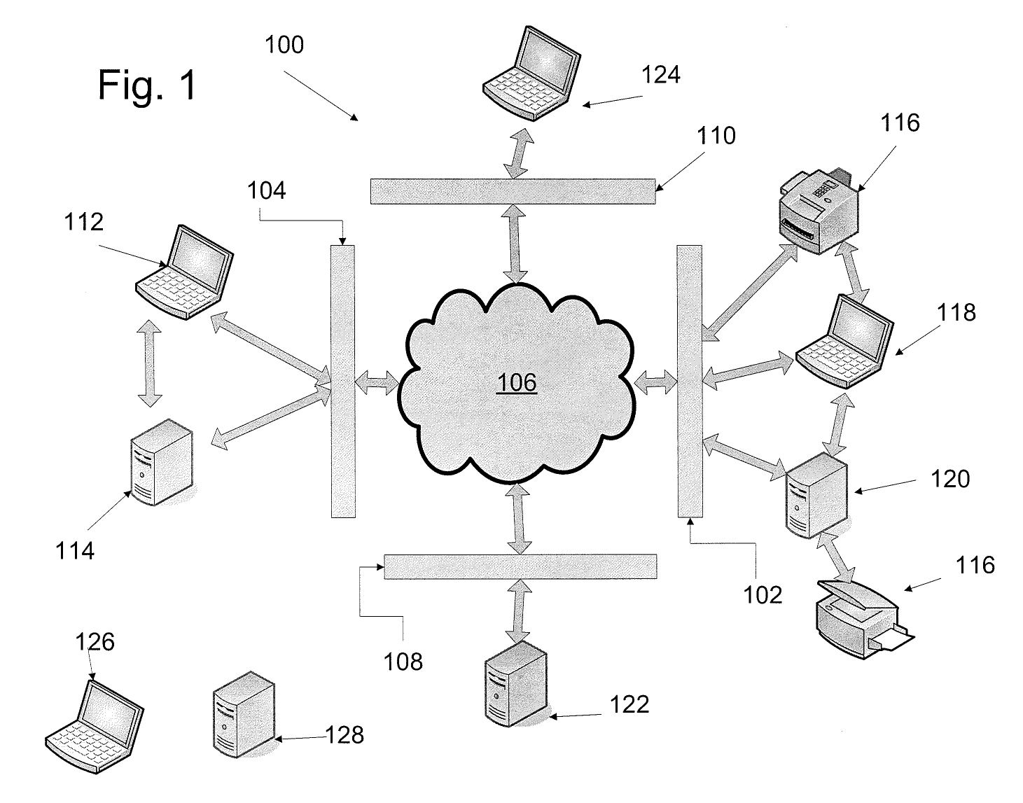

FIG. 1 is a schematic diagram of a system 100 for providing a cost-per-unit of ink to a customer. In one exemplary embodiment, the cost-per-unit of ink is a cost-per-milliliter (CPM). The following description uses cost-per-milliliter as an example, but it is contemplated that any other units of volume or weight may be used such as liter, ounce, gram, or fluid ounce to name a few examples. The cost of servicing a printing device is determined by the cost-per-unit of ink such that the amount paid by a customer generally corresponds to the amount of ink used by the customer. Moreover, the cost-per-unit of ink takes into account printer sustainment (e.g., a printer cartridge, a print head, a maintenance kit, and a service contract) and the amount of ink used by the customer's printing device.

The system 100 includes a customer-side network 102 in communication with a CPM provider network 104 over a wide area network (WAN) 106 such as the Internet. The system 100 may further include a third party hosting network 108 and/or an individual network 110.

The system 100 further includes a computer 112 and a storage system 114 on the CPM provider network 104. The customer network 102 includes one or more printers 116, that may be part of a fleet of printers for a company, for example. The customer side network 102 may also include a computer 118 and a storage system 120.

The printers 116 on the customer network 102 are generally large format printing devices such as large format printers or plotters. These printing devices generally print large pictures or images such as architectural drawings or color pictures for billboards or wrappings for trucks. It is contemplated that the printing devices may be located on more than one customer network.

The third party hosting network 108 may also include one or more storage systems 122. The storage system 122 may host a web site, web application, web interface, database, and/or the like for some or all the techniques described herein for calculating a CPM.

The individual network 110 may include one or computers 124 that allow a user to input certain parameters into the computer 124. The computer 124 may then communicate with the computer 112, the storage system 114, the storage system 122, or any combination thereof. This allows the user to input parameters and receive a CPM remotely, based on the parameters. The individual network 110 may be, for example, a user's home network, cellular phone network (e.g., GSM, TDMA, CDMA, or the like), a WiFi hotspot, or any other network.

In another embodiment, an operator may use a computer to communicate with the computer 112 and/or storage systems 114, 122 over the network 106 (e.g., the Internet). The computer may provide a web interface that allows the operator to input certain parameters and generate a CPM over the network 106. The server may be located at the provider network 104 or at a third party network 108 or some combination of both. For example, the web interface may be hosted by a third party, such as storage system 122, but the server and/or database containing the software and/or hardware to calculate the CPMs may be located at the provider network 104. In this example, the operator uses computer 124 to input the parameters into a web interface over the WAN 106. The hosted web interface then communicates that information, e.g., to computer 112 and/or storage system 114 on the provider network 104 for calculating the CPMs. After the CPMs are calculated, the CPMs are transmitted to the third party network 108 and presented to the operator through the web interface. The CPMs are thus transformed into visual objects and observable on the operator's computer 124.

In another embodiment, the operator is on the customer network 102 using a computer 118 to obtain the CPMs over the WAN 106.

In another embodiment, an operator uses the computer 118 or storage system 120 to input some information regarding the customer's printers. The computer 118 or storage system 120 may then connect to another computer or storage system on a different network (e.g., provider network 104, third party network 108, individual network 110, etc.) that completes the processing of the information and calculations of one or more CPMs.

In yet another embodiment, an operator may be using a computer 126 or storage system 128 that is not connected to any network. In this embodiment, information may be inputted into the computer 126 and/or storage system 128 and all processing and calculations are performed locally on the computer 126 and/or storage system 128. The computer 126 and/or storage system 128 will then transform and output the resulting one or more CPMs to an external device.

In another embodiment, the system can operate in a hosted cloud or client/server architecture. The system can provide for the capability of incorporating the cost of multiple hardware and software products and/or technologies into the calculated cost-per-milliliter. To support the needs of a dynamic and rapidly changing environment, the system may provide for real-time adaptive calculation of the cost-per-milliliter based upon the receipt of data broadcast from a printing device to the system over a computer network. The real-time data and calculation can then be accessed by any computer device attached to the system network.

For example, the printers 116 may continuously or intermittently broadcast their current ink usage (e.g., in milliliters) as well as information about their hardware or parts to the other devices on the customer network 102 or to any network connected to the WAN 106 such as networks 104, 108, or 110. The computer 118 and/or storage system 120 may compile this information and also broadcast this information over the WAN 106 to any connected network. Any of the computers and/or storage systems 112, 114, 122, and/or 124 may receive the broadcasted information and perform one or more actions with the information. For example, the computers and/or storage systems 112, 114, 122, and/or 124 may store the information in a database so that one or more CPMs can be calculated based on the information in the database. As another example, one or more CPMs may be calculated or updated after receiving the broadcasted information. As yet another example, service to one or more of the printers 116 may be performed based the broadcasted information, e.g., indicating that a part is broken or a maintenance kit needs to installed.

Users or operators using one computer may communicate with any of the computers or devices on the customer network. Likewise, in one form, users or operators using one computer may communicate with any of the other computers or storage systems on the CPM provider network as well as the individual network and third party network. In other embodiments, access to computers or storage systems on the CPM provider network and/or the individual network and/or third party network may be limited and/or may be restricted to certain users or operators.

As part of determining a CPM, one piece of information that may be used to compute a CPM is the amount of ink used by each printer that is to be covered by the CPM. The ink usage information may be retrieved from each printer manually by an operator. Or, software running on one or more devices, including but not limited to the computer 118 or storage system 120, may request the ink usage information for each printer 116 on the customer network 102. Once the ink usage information has been determined, it is forwarded for processing a CPM. For example, an operator may enter the ink usage information into the storage system 124 or computer 118 on the CPM provider network 104. As another example, the ink usage information may be transmitted, e.g., by computer 118 or storage system 120 to, e.g., computer 112, storage system 114, and/or storage system 122, e.g., through the WAN 106.

The system 100 is illustrated as an exemplary schematic diagram of relationships. Particular embodiments of the system 100 may utilize various computers instead of or in addition to computers in other configurations, and data may be stored in various storage systems instead of or in addition to storage system and/or generated in real time during operations of the system 100. The computers may be any type of computer including but not limited to, a desktop computer, a laptop computer, a personal digital assistant (PDA), smart phone, cell phone, or tablet computer. The storage system may be any type of server or database management system and may also be a computer as described above.

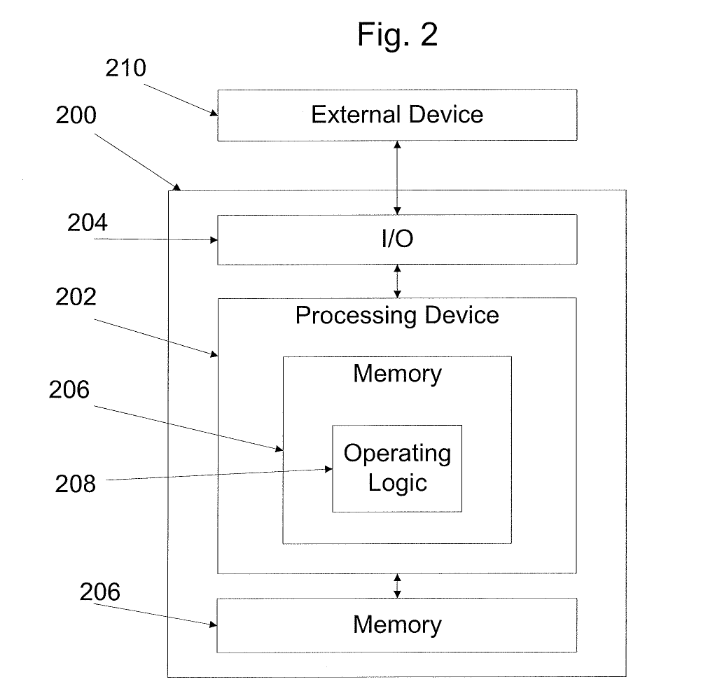

FIG. 2 is a schematic diagram of a computer 200. The computer 200 may be any of the computers 112, 118, 124, 126 shown in FIG. 1 as well as any of the storage systems 114, 120, 122, 128 shown in FIG. 1. Computer 200 includes a processing device 202, an input/output device 204, memory 206, and operating logic 208. Furthermore, computer 200 communicates with one or more external devices 210.

The input/output device 204 may be any type of device that allows the computer 200 to communicate with the external device 210. For example, the input/output device may be a network adapter, network card, or a port (e.g., a USB port, serial port, parallel port, VGA, DVI, HDMI, FireWire, CAT 5, or any other type of port). The input/output device 204 may be comprised of hardware, software, and/or firmware. It is contemplated that the input/output device 204 includes more than one of these adapters, cards, or ports.

The external device 210 may be any type of device that allows data to be inputted or outputted from the computer 200. For example, the external device 210 may be another computer, a server, a printer, a display, a storage device, an alarm, an illuminated indicator, a keyboard, a mouse, or a touch screen display. Furthermore, it is contemplated that the external device 210 may be integrated into the computer 200. For example, the computer 200 may be a smartphone, a laptop computer, or a tablet computer in which case the display would be an external device 210, but the display is integrated with the computer 200 as one unit, which consistent with the general design of smartphones, laptop computers, tablet computers, and the like. It is further contemplated that there may be more than one external device in communication with the computer 200.

Processing device 202 can be of a programmable type, a dedicated, hardwired state machine, or a combination of these; and can further include multiple processors, Arithmetic-Logic Units (ALUs), Central Processing Units (CPUs), or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

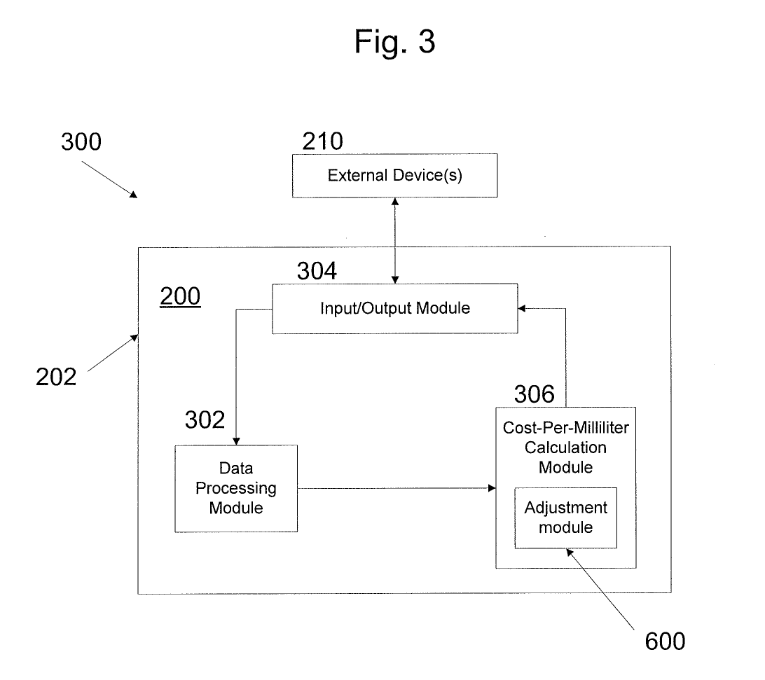

FIG. 3 is a schematic block diagram of a processing subsystem 300 for providing a CPM to a customer. The processing subsystem 300 includes a processing device 202 that may be part of a computer 200 (or a storage system or distributed computing device). The processing device 202 includes modules 302, 304, 306, 600 configured to provide multiple functionalities relating to providing the CPM as well as providing other functionalities. The exemplary embodiments described herein may include a number of modules providing a number of functionalities. A module may be implemented as operations by software, hardware, artificial intelligence, fuzzy logic, or any combination thereof, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or in part with other modules or devices. The operations of any module may be performed wholly or partially in hardware/software or by other modules. The presented organization of the modules is exemplary only, and other organizations, configurations and arrangements are contemplated.

The computer 200 includes an input/output module 304 that receives ink usage and printing device information (e.g., type of printer, number of cartridges, number of print heads, maintenance kits, service contract) from an external device 210. The input/output module 304 passes the information to a data processing module 302. In one exemplary embodiment, the data processing module 302 analyzes and processes the ink usage and printing device information based on type (e.g., ink usage, maintenance, parts, or adjustments). In addition, the data processing module may perform the process the ink usage information in technique 400 including calculating the average amount of milliliters of ink used in operation 408 as well as performing some operations in technique 500. It is contemplated that the printing device information may be categorized differently as well as distributed to different modules.

After the data processing module 302 receives and processes the ink usage and printing device information, the processed data is passed to the cost-per-milliliter calculation module 306, which determines a CPM. The cost-per-milliliter calculation module 306 generally performs some of the operations in technique 500 to calculate the CPM. In addition, the cost-per-milliliter calculation module 306 may also include an adjustment module 600 to process and incorporate any adjustments in the CPM.

After the CPM is calculated, the CPM is transferred to the input/output module 304, where the CPM is processed, transformed, and outputted to the external device 210. In one embodiment, the external device 210 may be any type of device that allows an operator to visually observe the CPM. For example, the external device 210 may include, but is not limited to, a display or monitor, a computer with a display, a cell phone, a smart phone, a PDA, a terminal with a display connected to it, a printer, a server or distributed processing system or a laptop or desktop computer. The various modules 302, 304, 306, and 600 may be implemented in operating logic 208 as part of the processing device 202.

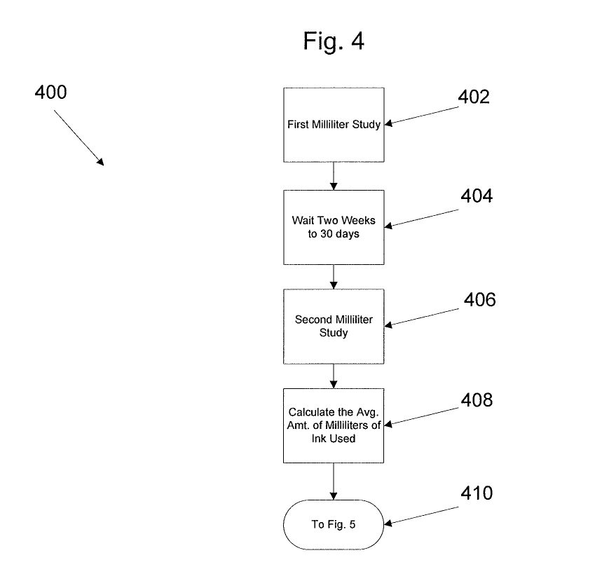

The schematic flow diagram in FIG. 4, and the related descriptions which follow, are illustrative embodiments of a technique for calculating a CPM for one or more printing devices. Operations illustrated are understood to be exemplary only, and operations may be combined or divided, and added or removed, as well as re-ordered in whole or in part, unless explicitly stated to the contrary. The techniques 400 and 500 may be implemented by one or more computers executing one or more computer programs stored on a computer readable medium. The computer program comprises instructions or operating logic causing the computer to execute one or more of the operations of the techniques 400 and 500. In certain embodiments, the computer program may be comprised of modules, such as those described herein.

The technique 400 includes an operation 402 in which a first milliliter study is conducted. During a milliliter study, the amount of milliliters of ink used for each printing device in a fleet of printing devices at a customer site is collected. The collection of this information may occur in a variety of ways.

In one embodiment, an operator from a CPM provider may manually record all of the ink usage totals for each printer. In another embodiment, an operator may enter the information into an appropriate computer or storage system on the CPM provider network 104 or the third party network 108 through the WAN 106.

In another embodiment, a software program collects the total amount of milliliters of ink used by each printer. These programs, for example utilizing the data processing module 302, may be executed on computer 118 or storage system 120 on the customer network 102 or may be executed on any computer or server on a different network 104, 108, 110 that communicates with the customer network 102 through a WAN 106 such as the Internet to collect the total amount of ink used.

Once this information has been collected about each printer, the information may be entered into the computer 112 or storage system 114 in a variety of ways, e.g., as discussed above. In one embodiment, an operator manually inputs the data into the computer 112 through a keyboard connected to the computer 112.

In another embodiment, the information is transmitted from the customer network 102 to the computer 112 or storage system 114 on the CPM provider network 104. In this embodiment, the information may be stored on a computer 118 or storage system/server 120 on the customer network 102 until the appropriate time for transmitting the data to the CPM provider network 104. The information includes the amount of ink used by a printer.

For all of the various embodiments, the receipt, storage, and processing of the ink usage information and any information regarding the printing device may be handled by the data processing module 302.

Next, operation 404 includes waiting for a period of time. In one form, the period of time is approximately two weeks to 30 days. In other embodiments, other suitable time periods may be employed. The time period is selected to be a sufficient amount of time to determine the average ink usage by a company or organization during normal use. For example, the two weeks to 30 days time period may allow any high volume ink usage days to balance out with low volume ink usage days. Extending beyond 30 days may be beneficial for further determining average ink usage during normal use.

Operation 406 includes a second milliliter study. The second milliliter study should generally be conducted in a similar manner as the first milliliter study. The purpose of the second milliliter study is to collect the amount of ink used by each printer, e.g., in a fleet.

In operation 408, the average milliliters of ink used based on printer model over the milliliter study time is calculated. For example, if the milliliter study time was 30 days, the average ink usage in milliliters is calculated over a 30 day period. In operation 410, the information is transferred to the scheme 500. The cost-per-milliliter module 306 uses the information from the data processing module 302 to calculate one or more CPMs as described in technique 500.

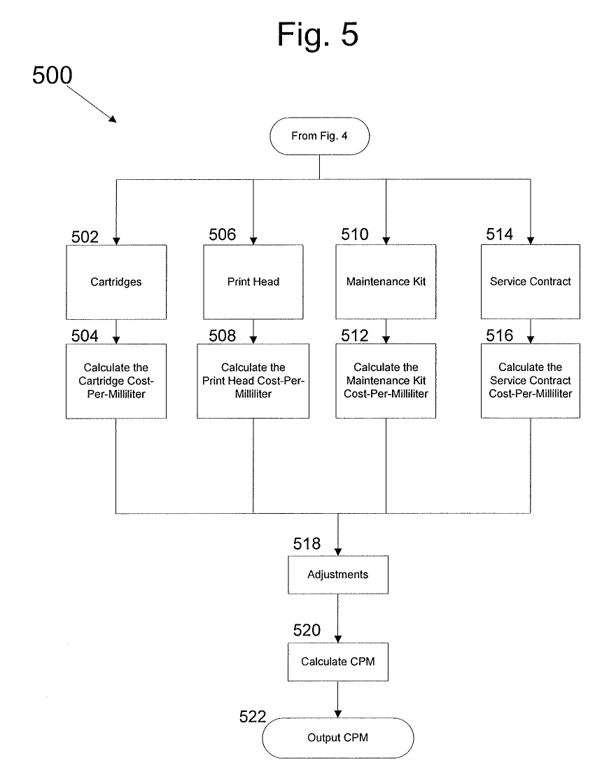

The schematic flow diagram in FIG. 5, and the related descriptions which follow, are illustrative embodiments of a technique for calculating a cost-per-unit of ink for a printer. The following description uses cost-per-milliliter as an example, but it is contemplated that any other units of volume or weight may be used such as liter, ounce, gram, or fluid ounce to name a few examples.

Operation 502 includes determining or calculating the cartridge ink cost and yield. Each model of printing device is unique and uses a different quantity of ink. The cartridge yield may be inputted into the system, such as data processing module 302, based on information from the manufacturer of the cartridge or printer or based on experience. In addition the cartridge yield may be adjusted to compensate for inaccurate values being supplied by the manufacturer or based on experience with that particular cartridge. For example, the cartridge yield may be adjusted by 10%. Large format printing devices often have multiple colors of ink (e.g., four, eight, or more colors). Thus, calculating the cost and yield is performed for each color.

In operation 504, the cost-per-milliliter calculation module 306 calculates the cartridge cost-per-milliliter by dividing the cost of a cartridge by the yield in milliliters, but other units of volume or weight may be used. If the cost and yield for different colors of cartridges are different, the various cartridge costs-per-milliliters for each color may be averaged resulting in one average cartridge cost-per-milliliter.

Operation 506 includes determining or calculating the print head cost and yield. The print head yield may be inputted into the system, such as data processing module 302, based on information from the manufacturer of the cartridge or printer or based on experience. In addition the print head yield may be adjusted to compensate for inaccurate values being supplied by the manufacturer or based on experience with that particular print head. For example, the print head yield may be adjusted by 10%. Large format printers often have multiple colors of ink (e.g., four, eight, or more colors). Thus, calculating the cost and yield is performed for each color although most printers have two colors per print head.

In operation 508, the cost-per-milliliter calculation module 306 calculates the printer head cost-per-milliliter by dividing the cost of a print head by the yield in milliliters, but other units of volume or weight may be used. If the cost and yield vary for between print heads, the various print head costs-per-milliliters for each color may be averaged resulting in one average print head cost-per-milliliter.

Operation 510 includes determining and inputting into data processing module 302 information regarding the maintenance kits for a particular printer model as well as determining cost and yield for the maintenance. Maintenance kits may include service stations, cutters, and/or carriage assemblies. Operation 510 may also include preventative maintenance kits, maintenance contracts, and labor costs for maintenance and preventative maintenance. These factors may be adjusted as described below. Generally, the cost for maintenance kits is determined for a three year period. In one embodiment, the cost of a cutter is calculated over one year because it will be replaced more frequently than other components. The time period or yield for a maintenance kit may given by a manufacturer or based on experience.

In operation 512, the cost-per-milliliter calculation module 306 calculates the maintenance kit cost-per-milliliter by adding the cost of all of the maintenance kits for a given period of time and dividing by the amount of ink in milliliters to be used during the same period of time based on the average milliliters of ink to be used for that time period as calculated in operation 408.

Operation 514 includes determining and inputting the cost and length of the service contract into the data processing module 302. In operation 516, the cost-per-milliliter calculation module 306 calculates the cost-per-milliliter for the service contract by dividing the contract cost by the amount of ink to be used during the same time period based on the average milliliters of ink to be used for that time period as calculated in operation 408.

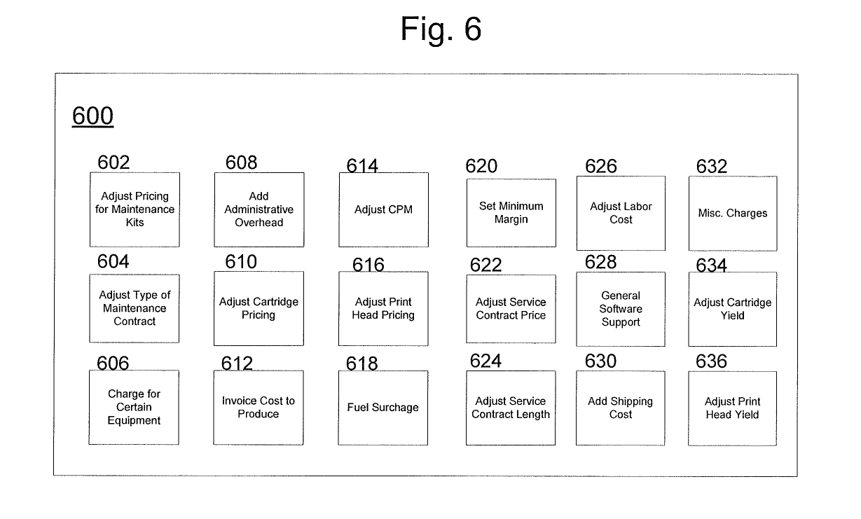

In operation 518, the adjustments module 600, which may be part of the cost-per-milliliter calculation module 306, applies any adjustments to the various inputs and costs-per-milliliter as discussed with respect to FIG. 6.

In operation 520, after any adjustments have been applied, the cartridge cost-per-milliliter, the print head cost-per-milliliter, the maintenance kit cost-per-milliliter, and the service contract cost-per-milliliter are added by the cost-per-milliliter calculation module 306, which results in a total cost-per-milliliter for a printer. In operation 522, the cost-per-milliliter may be outputted to an external device 210. Although FIG. 5 illustrates four types of printer sustainment (i.e., a printer cartridge, a print head, a maintenance kit, and a service contract), other types of printer components, parts, and/or services may be used in addition to or in place of the four types shown in FIG. 5.

FIG. 6 shows an adjustments module 600, which may be part of the cost-per-milliliter calculation module 306, that includes a number of adjustments that may be made to change a CPM. The cost-per-milliliter calculation module 306, the data processing module 302, and/or the input/output module 304 may present a user one or more adjustments on an external device 210 to select from and incorporate into the CPM. Once a user selects one of the adjustments in the adjustment module 600, the calculation module 306 may update the CPM to reflect the selected adjustment(s).

Adjustment 602 allows a user to adjust the price of maintenance kit such as by adding or subtracting a number or adjusting using a percentage such as reducing the price by 10%.

Adjustment 604 allows the type of maintenance contract to be selected. This situation may occur when an OEM and other companies provide service contracts for a particular maintenance kit.

Adjustment 606 is for charging for certain equipment. The cost of the equipment will be incorporated into the calculated CPM. For example, a customer may choose to purchase an additional printer or parts. The cost of these items may be added into the CPM calculation rather than billing the customer for the items independently.

Adjustment 608 adds administrative overhead costs to the CPM. Administrative overhead may include, for example, the costs associated with servicing a large or small client or a client that requires more frequent billing that would drive up the administrative costs for the CPM provider. Administrative overhead may also include recovering costs for preparing and processing contracts. This adjustment allows the CPM provider to pass that cost on to the customer through the CPM.

Adjustment 610 allows the price or cost of a cartridge to be adjusted. For example, the price may be adjusted by adding or subtracting a number from the price or adjusting the price using a percentage such as reducing the price by 10%.

Adjustment 612 is for invoicing the cost to produce. This allows the CPM provider to pass the invoice cost and other associated costs to produce on to the customer through the CPM.

Adjustment 614 allows the CPM to be adjusted by increasing or decreasing the CPM by a percentage or adding or subtracting a number directly to the CPM.

Adjustment 616 allows the price or cost of a print head to be adjusted. For example, the price may be adjusted by adding or subtracting a number from the price or adjusting the price using a percentage such as reducing the price by 10%.

Adjustment 618 is for adding a fuel surcharge to the CPM. The fuel surcharge adjustment 618 is for situations where shipping and service travel costs do not adequately cover the cost of servicing the client or providing the replacement parts to the client. For example, during certain economic periods, e.g., when the price for oil is higher, shipping costs are generally higher as well.

Adjustment 620 allows a CPM provider to set a minimum margin the CPM. For example, a CPM provider may wish to make a 20% profit for servicing a large format printer. The adjustment 620 allows an operator to input a minimum margin such as 20% into the CPM calculation.

Adjustment 622 allows the price or cost of a service contract to be adjusted. For example, the price may be adjusted by adding or subtracting a number from the price or adjusting the price using a percentage such as reducing the price by 10%.

Adjustment 624 allows the length of the service contract to be adjusted such as increasing or decreasing the contract's length. The length of the contract may affect the CPM because of the frequency of maintenance kit installations.

Adjustment 626 allows the labor costs to be adjusted. For example, the labor for performing servicing or maintenance including preventive maintenance may be added, removed, or adjusted. As another example, a customer may choose to install its own maintenance kits so no labor costs should be charged to the customer.

Adjustment 628 is for general software support and may be included into the CPM. This software may include various functionalities. In addition, this software may be used for supporting and monitoring a printer at a customer's location. The adjustment may be entered as a CPM value or a percentage.

Adjustment 630 allows additional shipping costs to be added into the CPM calculation. This shipping cost may be, for example, the cost of cartridges, print heads, maintenance kits, and the like to the customer. The shipping cost may be added as a percentage of the value of the item being shipped. Moreover, this may be convenient for the customer because the cost is part of the CPM and not an independent charge.

Adjustment 632 is for adjusting or adding additional miscellaneous charges and passing those costs on to the customer through the CPMs.

Adjustment 634 is for adjusting the cartridge yield. Some cartridges may not achieve the volume or yields as stated by the manufacturer. It may be beneficial to adjust the cartridge yield by a certain percentage such as 10% to account for the loss. Each color cartridge may be adjusted independently or together.

Adjustment 636 is for adjusting the print head yield. Some print heads may not achieve the volume or yields as stated by the manufacturer. It may be beneficial to adjust the print head yield by a certain percentage such as 10% to account for the loss. Each print head may be adjusted independently or together.

Based on a CPM calculation, a variety of actions may be taken. For example, the CPM may be transmitted to the customer such as by email or other electronic means or postal mail. As another example, the CPM analysis may show that a customer's current printer fleet is inefficient for handling the volume of printing required by the customer. Therefore, the printer fleet at the customer's site(s) may be redesigned based on the CPM. For example, one or more printers may be added to compensate for a large volume of printing. In another embodiment, some older printers may be sold and replaced by one or more larger-capacity new machines or smaller-capacity machines depending on printing volume. In yet another embodiment, printers may be relocated to other areas within the company so that the volume of printing is reduced on inadequate machines and other higher volume printers will take their place. In another embodiment, printing to certain machines may be restricted or encouraged based the cost of printing to devices in that model group or category.

In another example, an action that may be taken based on the CPM is adjusting when paper, parts (e.g., cartridges, print heads, kits, etc.), and servicing are scheduled at a customer location.

The present application may be implemented on any type of computer and using a variety of different software. For example, the present application may be implemented using Microsoft Excel, Microsoft Access, Microsoft SQL Server, any of Oracle's database systems, MySQL, custom software modules, custom databases, any other appropriate software or database, or any combination thereof. When the computer or storage system is configured as a database, it is contemplated that the database may be any type of database, such as relational, hierarchical, object-oriented, and/or the like.

A computer readable medium may refer to any tangible storage and/or transmission medium that participate in providing instructions to a processing device for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium.

In one example, an apparatus includes a computer including a calculation module, wherein the calculation module is operable to calculate at least one cost-per-unit of ink for a large format printing device based on at least a cartridge cost and a print head cost; and an external device in communication with the computer, wherein the external device is structured to output the cost-per-milliliter.

Other features of the example may include an adjustment module having one or more adjustments, wherein the adjustment module is structured to allow a user to select one or more of the adjustments to adjust the cost-per-unit of ink; the cost-per-unit of ink includes an ink cartridge yield reduction; the cost-per-unit of ink includes a minimum margin; the cost-per-unit of ink further comprises a maintenance cost; the cost-per-unit of ink further comprises a service contract cost; the cost-per-unit of ink is cost-per-milliliter.

In yet another example, a system includes a first computer structured to communicate with a second computer over a network; wherein the first computer is structured to transmit information about a large format printer to the second computer over the network; and wherein the second computer includes memory for storing the information and a processing device is structured to process the information and calculate a cost-per-unit of ink for the printer based on a cartridge cost and a print head cost.

Other features of the example may include that the processing device is operable to incorporate an adjustment into cost-per-unit of ink; the second computer is structured to transmit the cost-per-unit of ink to the first computer, and wherein the first computer includes display means for displaying the cost-per-unit of ink; the first computer communicates with the second device through a web interface over the network; the first computer is structured to receive at least part of the information from a third computer at a customer site; the first computer communicates with the second computer through a web application over the Internet; and the cost-per-unit of ink is cost-per-milliliter.

In another example, a computer-implemented method for calculating a cost-per-unit of ink with a computer having a processing device, wherein the method includes: receiving, with the computer, ink usage information about a plurality of printers; calculating, with the processing device, a cost-per-milliliter for the printers, wherein the processing device adjusts the cost-per-milliliter based on an adjustment; and displaying the cost-per-milliliter on an external device.

Other features of the example may include recommending a redesign of the printers based on the cost-per-milliliter; presenting the one or more adjustments on a display means for a user to select one or more of the adjustments; receiving an order for a printer based on the cost-per-milliliter; recommending changing a printer configuration based on the cost-per-milliliter.

In yet another example, a computer program product, comprising: a computer readable medium having computer readable program, wherein the computer readable program when executed on a computer causes the computer to: receive ink usage information about a large format printing device, calculate a cost-per-milliliter for the printing device using the information, and adjust the cost-per-milliliter based on a selected one or more adjustments.

Other features of the example may include that the computer readable program when executed on the computer further causes the computer to: transmit the cost-per-milliliter to another computer over a network; and output the cost-per-milliliter on a display.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An apparatus, comprising:
a computer including a calculation module, wherein the calculation module is operable to calculate at least one cost-per-unit of ink for a large format printing device based on a cost of printer sustainment and based on ink usage, wherein the ink usage is based on an amount of ink used by the large format printing device over a period of time; and
an external device in communication with the computer, wherein the external device is structured to output the cost-per-milliliter.

2. The apparatus of claim 1, wherein the printer sustainment includes at least one of a printer cartridge, a print head, a maintenance kit, and a service contract.

3. The apparatus of claim 1, the computer further comprising a data processing module operable to receive and process the cost of printer sustainment and the ink usage.

4. The apparatus of claim 1, wherein the cost-per-unit of ink is cost-per-milliliter of ink.

5. The apparatus of claim 1, wherein the computer further comprises an adjustment module having one or more adjustments, wherein the adjustment module is structured to allow a user to select one or more of the adjustments to adjust the cost-per-unit of ink.

6. The apparatus of claim 5, wherein the adjustment includes at least one of adjust pricing for maintenance kits, adjust type of maintenance contract, charge for certain equipment, add administrative overhead, adjust cartridge pricing, invoice cost to produce, adjust the cost-per-unit of ink, adjust print head pricing, fuel surcharge, set minimum margin, adjust service contract price, adjust service contract length, adjust labor cost, general software support, add shipping cost, miscellaneous charge, adjust cartridge yield, and adjust print head yield.

7. A system, comprising:
a first computer structured to communicate with a second computer over a network;
wherein the first computer is structured to transmit information about ink usage by a large format printing device at a customer location to the second computer over the network; and
wherein the second computer includes memory for storing the ink usage information and a processing device is structured to process the ink usage information and calculate a cost-per-unit of ink for the large format printing device based on a cost of printer sustainment and based on the ink usage information.

8. The system of claim 7, wherein the processing device is operable to incorporate an adjustment into the cost-per-unit of ink.

9. The system of claim 7, wherein the second computer is structured to transmit the cost-per-unit of ink to the first computer, and wherein the first computer includes display means for displaying the cost-per-unit of ink.

10. The system of claim 7, wherein the first computer is structured to communicate with the second computer through a web interface over the network, wherein the network is the Internet.

11. The system of claim 7, wherein the first computer is structured to receive at least part of the ink usage information from a third computer at a customer site.

12. The system of claim 7, wherein the cost-per-unit of ink is cost-per-milliliter of ink.

13. A computer-implemented method for calculating a cost-per-unit of ink with a computer having a processing device, the method comprising:
receiving and processing, with the computer having a data processing module, ink usage information about a large format printing device;
calculating, with the processing device having a calculation module, a cost-per-unit of ink for the printing device based on the cost of printer sustainment and the ink usage information, wherein the processing device adjusts the cost-per-unit of ink based on one or more adjustments; and
displaying the cost-per-unit of ink on an external device.

14. The method of claim 13, further comprising:
transmitting, with the computer, the cost-per-unit of ink to a customer.

15. The method of claim 13, further comprising:
presenting the one or more adjustments on a display means for a user to select one or more of the adjustments for use calculating the cost-per-unit of ink.

16. The method of claim 13, further comprising:
receiving an order for a printing device based on the cost-per-unit of ink.

17. The method of claim 13, further comprising:
recommending changing a printer configuration based on the cost-per-unit of ink.

18. The method of claim 13, wherein the one or more adjustments include at least one of adjust pricing for maintenance kits, adjust type of maintenance contract, charge for certain equipment, add administrative overhead, adjust cartridge pricing, invoice cost to produce, adjust the cost-per-unit of ink, adjust print head pricing, fuel surcharge, set minimum margin, adjust service contract price, adjust service contract length, adjust labor cost, general software support, add shipping cost, miscellaneous charge, adjust cartridge yield, and adjust print head yield.

19. The method of claim 13, wherein the printer sustainment includes at least one of a printer cartridge, a print head, a maintenance kit, and a service contract.

20. A computer program product, comprising: a computer readable medium having a computer readable program, wherein the computer readable program when executed on a computer causes the computer to: receive, with the computer, ink usage information at a customer location about a large format printing device, calculate, with the computer, a cost-per-unit of ink for the large format printing device using the ink usage information and the cost of printer sustainment, and display, with the computer, the cost-per-unit of ink on an external device.

21. The computer program product of claim 20, wherein the computer readable program when executed on the computer further causes the computer to:
adjust the cost-per-unit of ink based on a selected one or more adjustments.

22. The computer program product of claim 21, wherein the selected one or more adjustments include at least one of adjust pricing for maintenance kits, adjust type of maintenance contract, charge for certain equipment, add administrative overhead, adjust cartridge pricing, invoice cost to produce, adjust the cost-per-unit of ink, adjust print head pricing, fuel surcharge, set minimum margin, adjust service contract price, adjust service contract length, adjust labor cost, general software support, add shipping cost, miscellaneous charge, adjust cartridge yield, and adjust print head yield.

23. The computer program product of claim 20, wherein the computer readable program when executed on the computer further causes the computer to:
transmit the cost-per-unit of ink to a customer over the Internet.

24. A method, comprising:
processing, with a computer having a data processing module, information about ink usage by a large format printing device over a period of time;
calculating, with the computer having a calculation module, a cost-per-unit of ink for the large format printing device based on a cost of printer sustainment and based on the ink usage information; and
outputting, with the computer having an input/output module, the cost-per-unit of ink on an external device.

25. The method of claim 24, wherein the printer sustainment includes at least one of a printer cartridge, a print head, a maintenance kit, and a service contract.

26. The method of claim 24, further comprising:
adjusting, with the computer having an adjustment module, the cost-per-unit of ink based on one more adjustments.

27. The method of claim 26, wherein the one or more adjustments include at least one of adjust pricing for maintenance kits, adjust type of maintenance contract, charge for certain equipment, add administrative overhead, adjust cartridge pricing, invoice cost to produce, adjust the cost-per-unit of ink, adjust print head pricing, fuel surcharge, set minimum margin, adjust service contract price, adjust service contract length, adjust labor cost, general software support, add shipping cost, miscellaneous charge, adjust cartridge yield, and adjust print head yield.

28. The method of claim 24, wherein the cost-per-unit of ink is cost-per-milliliter of ink.

29. The method of claim 24, further comprising:
transmitting the cost-per-unit of ink to a customer.
